(19) United States
(12) Patent Application Publication
(10) Pub. No.: US 2009/0100812 A1
(43) Pub. Date: Apr. 23, 2009

(54) Particulate filter

(75) Inventors: Hubert Felder, Holzwickede (DE); Georg Huethwohl, Soest (DE); Uwe Schumacher, Soest (DE)

Correspondence Address: CROWELL & MORING LLP;INTELLECTUAL PROPERTY GROUP, P.O. BOX 14300, WASHINGTON, DC, 20044-4300, US

(73) Assignee: PUREM ABGASSYSTEME GMBH & CO., KG, Unna (DE)

(21) Appl. No.: 11/659,186

(22) PCT Filed: Aug. 3, 2005
(86) PCT No.: PCT/EP2005/008397

§ 371 Date: Dec. 4, 2008

(30) Foreign Application Priority Data
Aug. 4, 2004 (DE) 10 2004 037 705.7
Dec. 15, 2004 (DE) 10 2004 060 307.3

(51) Int. Cl. B01D 46/12

(52) U.S. Cl. 55/484

(57) ABSTRACT

A particulate filter for separating particulates out of an exhaust gas flow of an internal combustion engine has a filter body with an inflow region and an outflow region. The filter body is formed by alternately arranged inflow ducts that are open toward the inflow region and are closed toward the outflow region, and outflow ducts that are open toward the outflow region and closed toward the inflow region. The filter body has a plurality of substantially planar filter plates arranged parallel to one another. Each of the inflow ducts and the outflow ducts is formed by adjacent filter plates, and is arranged in a housing. The inflow ducts are open at at least one of their lateral regions in such a way that the inflow region extends over at least two sides of the filter body. At least one sealing element is provided for sealing off the filter body in the outflow region relative to the housing.

### BACKGROUND AND SUMMARY OF THE INVENTION

This invention relates to a particulate filter for separating particulates out of an exhaust gas flow of an internal combustion engine.

A filter for separating impurities out of exhaust gases is known from German document DE 42 34 930 A1. This filter has a filter body with a plurality of filter plates which are composed of sintered metal powder and are arranged so as to form a plurality of adjacent flow ducts. The individual filter plates are of corrugated shape and are traversed by flow in the longitudinal direction or axial direction. The corrugated shape of the filter plates results, however, in the formation of longitudinal ducts which are delimited from one another and become very quickly clogged with ash, and can therefore adversely affect the performance of the filter. A further problem of this particulate filter is the complex axial sealing arrangement via lateral clamping of the individual filter pockets, and the fact that the flow can enter the filter body from only one side, leading to higher exhaust gas back pressures.

A similar particulate filter is described by German document DE 102 19 415 A1. However, the individual filter plates in this filter are arranged in a V-shape relative to one another, so as to form filter pockets or inlet and outlet ducts which narrow conically. Here, too, there is a problem in the connection of the individual filter pockets, and the sealing arrangement required for this purpose. This problem can only be eliminated by means of complex design solutions.

A filter arrangement in which the above described sealing problems do not occur is known from German document DE 100 35 544 A1. Here, the exhaust gas can flow in over a large area from all sides and leave the filter through a central outflow bore. It is again a problem here, however, that a part of the filter face must be punched out in order to generate the central outflow bore, leading on the one hand to increased expenditure in production and on the other hand to the generation of waste and therefore to a filter face which is reduced in size. A further disadvantage of this filter arrangement is that, as a result of the central outflow bore, it is necessary for the exhaust gas flow to be deflected several times, leading to an increase in the exhaust gas back pressure. In a solution of this type, a reduction in the exhaust gas back pressure can only be achieved by increasing the size of the entire particulate filter, which often brings about installation space problems. In addition, accumulations of soot about the central outflow bore have been observed in filter arrangements of this type, which can lead to partially intense exothermic reactions during the regeneration of the particulate filter.

A particulate filter which is composed of individual star-shaped filter pockets arranged about the periphery of a central bore is known from international publication WO 02/102494 A1. Flow passes around the filter pockets, and the filter pockets are capable of storing a relatively large quantity of ash. However, the known filter geometry only permits the design of filters with relatively small diameters, since it is not possible to integrate a sufficiently large filter face in a predefined volume as a result of the star-shaped design.

It is an object of the present invention to provide a particulate filter for separating particulates out of the exhaust gas flow of an internal combustion engine, in which particulate filter simple and reliable sealing is provided in particular in the outflow region.

According to the invention, this problem is solved by the features claimed.

A sealing element according to the invention serves to seal off the filter body with respect to the housing in the outflow region of the particulate filter, and therefore forms a separation, which can be provided with little structural expenditure, between the uncleaned gas side and the cleaned gas side of the particulate filter, with reliable sealing of the filter body being ensured.

In one embodiment of the invention, the sealing element is designed in the form of a comb with teeth that engage in lateral openings of the inflow ducts, and in this way ensure sealing of the inflow ducts with respect to the housing. It is particularly advantageous here that the individual filter plates need not be provided with notches; rather, only the sealing element, which is very much easier to adapt, is matched to the shape of the filter plates. This makes cost-effective production of the particulate filter according to the invention possible with a highly reliable process, with the entire filter body being stiffened at the same time, since the latter is not only sealed off by the sealing element but is also reliably connected to the housing. In addition, the teeth according to the invention of the sealing element which is designed in the form of a comb ensure a considerably improved degree of heat dissipation, which is advantageous particularly when the sealing element is to be welded to the filter plates, so that damage to the filter plates is advantageously prevented.

As a result of the inflow and outflow ducts which run substantially parallel to one another, the exhaust gas flowing to the filter body of the particulate filter according to the invention can flow through the filter body in the axial direction substantially without deflection, resulting in a very low exhaust gas back pressure. This is facilitated by letting the exhaust gas flow into the filter body at at least two sides, such that a larger quantity of exhaust gas can therefore be processed in a given period of time. As a result of the uniform flow through the filter body, the soot advantageously accumulates in a far more uniform manner within the filter body, leading to better utilization of the volumetric capacity of the filter body.

In this context, it is also advantageous that, in the production of the filter plates for the particulate filter according to the invention, no waste is accrued as a result of a central outflow bore being dispensed with, and that the individual filter plates can be designed to be of almost any desired size, leading to a larger storage capacity for soot and ash. In addition, the invention offers a larger receiving volume for soot particles and ash than known particulate filters for the same installation space.

In order to increase the inflow area of the filter body and therefore further reduce the exhaust gas back pressure generated by the particulate filter according to the invention, in an advantageous refinement of the invention, the inflow ducts are open at their two lateral regions in such a way that the inflow region extends over three sides of the filter body.

If, in a further advantageous embodiment of the invention, the sealing element is connected by an additional clamping element to the filter body, a further improved attachment of the sealing element to the filter body is obtained, and further improved heat dissipation during any welding process is also provided. This advantageously simplifies the production of the particulate filter according to the invention.

Further advantageous embodiments and refinements of the invention are reflected in dependent claims.

Exemplary embodiments of the invention are illustrated in the drawings.

### BRIEF DESCRIPTION OF THE DRAWINGS

FIG. 1 shows a section through a particulate filter according to the invention;

FIG. 2 shows a longitudinal section through the particulate filter along line II-II of FIG. 1;

FIG. 3 shows a perspective view of the outflow ducts;

FIG. 4 shows the outflow ducts of FIG. 3 with a sealing element which seals off the filter body with respect to the housing;

FIG. 5 shows a first embodiment of the sealing element according to the invention for sealing off the filter body with respect to the housing;

FIG. 6 is an enlarged illustration of the sealing element of FIG. 5;

FIG. 7 shows a side view of the sealing element of FIG. 5 with an additional clamping element;

FIG. 8 shows a second embodiment of the sealing element according to the invention for sealing off the filter body with respect to the housing;

FIG. 9 shows a rear view of the sealing element of FIG. 8;

FIG. 10 shows a third embodiment of the sealing element according to the invention for sealing off the filter body with respect to the housing;

FIG. 11 shows the sealing element of FIG. 10 with additional clamping elements;

FIG. 12 shows a plan view of the first embodiment of the sealing element;

FIG. 13 is an enlarged perspective illustration of the sealing element of FIG. 12;

FIG. 14 shows a plan view of the second embodiment of the sealing element;

FIG. 15 is an enlarged perspective illustration of the sealing element of FIG. 14;

FIG. 16 shows a plan view of the third embodiment of the sealing element; and

FIG. 17 is an enlarged perspective illustration of the sealing element of FIG. 16.

### DETAILED DESCRIPTION OF THE INVENTION

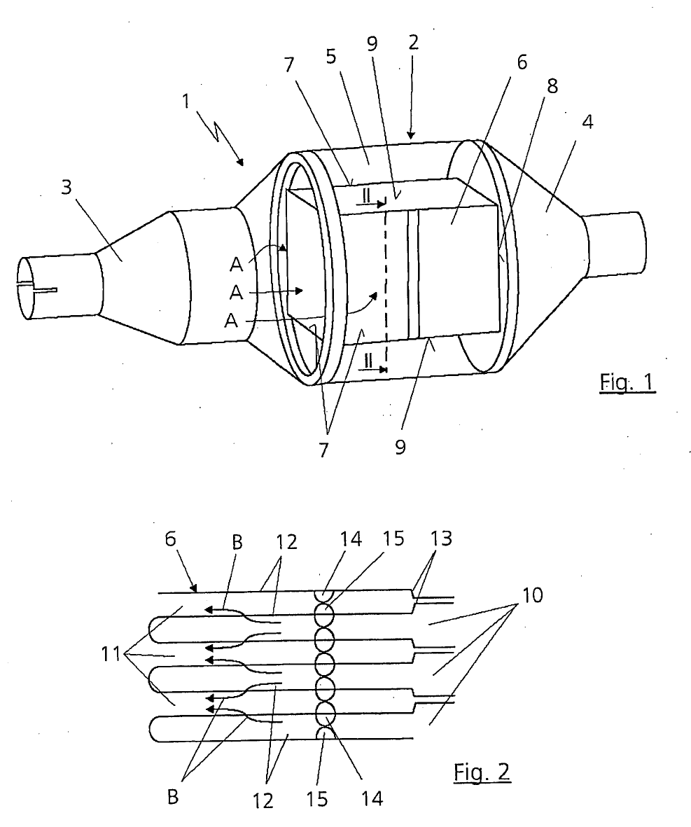

FIG. 1 shows a particulate filter 1 for separating particulates out of an exhaust gas flow of an internal combustion engine (not illustrated), which particulate filter 1 has a housing 2. In the illustrated embodiment, the housing 2 is circular in cross section over its entire length and has an inflow pipe 3 and an outflow pipe 4 which can be integrated into an exhaust line (not illustrated) of the internal combustion engine. A filter body 6 is arranged in a central section 5, situated between the inflow pipe 3 and the outflow pipe 4, of the housing 2, which filter body 6 has an inflow region 7 and an outflow region 8. The filter body 6 is of substantially quadrangular design and has respective closure plates 9 at its upper side and its lower side. The outflow region 8 is situated at that side of the filter body 6 which faces toward the outflow pipe 4, while the three remaining sides of the filter body 6 form the inflow region 7. As is illustrated by the arrows denoted by “A”, it is therefore possible for the exhaust gas flow to enter the filter body 6 from three sides.

The section in FIG. 2 illustrates the design of the filter body 6 in more detail. The filter body 6 is formed by alternately arranged inflow ducts 10 and outflow ducts 11. Here, the inflow ducts 10 are open toward the inflow region 7 and are closed toward the outflow region 8, whereas the outflow ducts 11 are open toward the outflow region 8 and are closed toward the inflow region 7. The inflow ducts 10 and the outflow ducts 11 are in each case formed by two adjacently arranged filter plates 12 which are preferably composed of a substrate material which is permeable to gas and is coated with a sintered metal powder. As a result of the exhaust gas pressure, the exhaust gas flows from the inflow ducts 10, as per the arrows “B”, through the filter plates 12 and into the outflow ducts 11. As the exhaust gas flows through, the particulates, present in particular in the form of soot, which are contained in the exhaust gas flow are deposited on the filter plates 12 in a way known per se.

The closure of the outflow ducts 11 in the inflow region 7 is in the present case realized in that the two filter plates 12 which form the outflow ducts 11 are in each case provided in the inflow region 7 with respective angled portions 13 in the direction of those adjacent filter plates 12 with which they form the outflow duct 11. The two angled portions 13 then come into contact with one another and are preferably connected to one another by welding. For this purpose, it is for example possible to use a TIG welding process, as is known per se. Alternatively, a soldering or adhesive process could also be used if the required strength can be provided in this way.

In the same way, it would also be possible to angle the inflow ducts 10, and weld the latter to one another, in the outflow region 8 in order to close them off. In the present case, this is accomplished by bending a filter plate 12 which forms the entire inflow duct 10, with the result that, although the individual filter plate 12 has a relatively large length, a considerable amount of work can be saved.

It can also be seen in FIG. 2 that the filter plates 12, which run parallel to one another and are substantially planar, are provided with, for example, knob-shaped depressions 14 and elevations 15 in the direction of the adjacent filter plate 12. This prevents the filter plates 12 from being pressed against one another by the pressure of the exhaust gas flow.

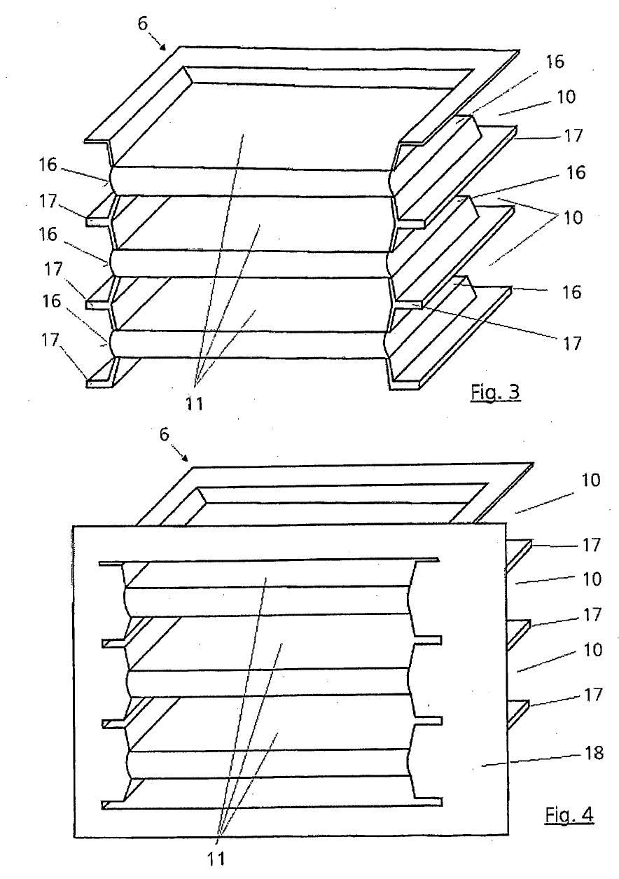

It can be seen from the illustration of a part of the filter body 6 in FIG. 3 that the inflow ducts 10 are also open at their lateral regions 16 or have lateral openings 16a, so that the inflow region 7, as mentioned above, extends over three sides of the filter body 6. Alternatively, one of the two lateral regions 16 of the inflow ducts 10 could be closed off, for example by means of a weld, as a result of which the inflow region 7 would extend over only two sides of the filter body 6. In contrast, the outflow ducts 11 are closed off in their two lateral regions 17 by welding the filter plates 12 which form said outflow ducts 11, in order to prevent exhaust gas leaving the filter body 6 at any point other than the outflow region 8. It would also be possible here if appropriate to use a suitable soldering or adhesive process.

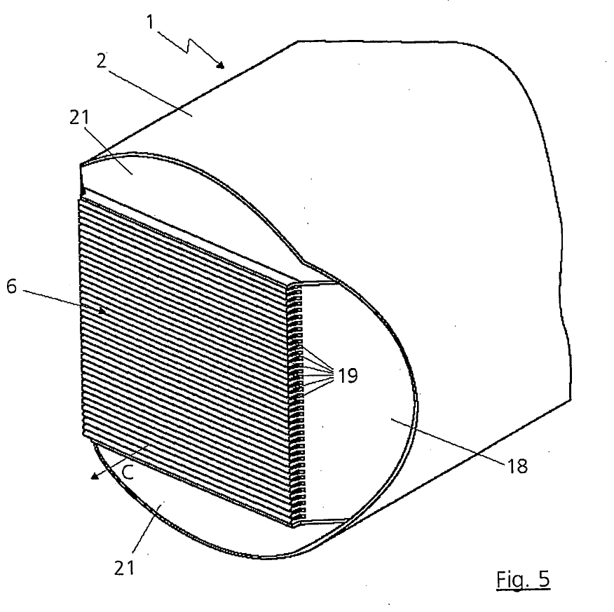

FIG. 4 shows, in addition to the illustration as per FIG. 3, a sealing element 18 which is plate-shaped in the present embodiment and serves to seal off the filter body 6 from the housing 2 in the outflow region 8. The sealing element 18 therefore forms the division between the uncleaned gas side and the cleaned gas side of the particulate filter 1. The filter body 6 is preferably connected to the sealing element 18 by means of welding. The connection of the sealing element 18 to the housing 2 can likewise be provided by means of welding.

FIG. 5 illustrates a sealing element 18 which serves to seal off the filter body 6, in its outflow region 8, from the housing 2. In this way, the sealing element 18 forms the division between the uncleaned gas side and the cleaned gas side of the particulate filter 1. The sealing element 18 is designed in the form of a comb and has a plurality of teeth 19, between which are situated respective cut-outs 20. In the present case, in each case one of the sealing elements 18 is situated on each side of the filter body 6. It can also be seen in FIG. 5 that, in order to seal off the housing 2 with respect to the filter body 6, two covering plates 21 are also provided in addition to the sealing element 18, which covering plates 21 ensure sealing of the region above and below the filter body 6. The covering plates 21 can be connected to the filter body 6 and/or the housing 2 by means of welding or another suitable process. Here, the sealing element 18 and the two covering plates 21 are matched to the shape of the opening of the housing 2, as a result of which the rectangular filter body 6 can be integrated into the round housing 2.

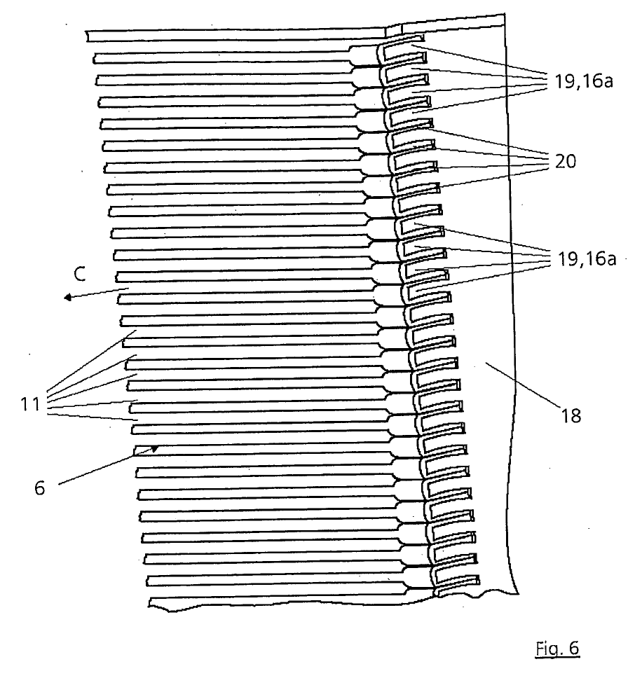

As can be more clearly seen in FIG. 6, the teeth 19 of the sealing element 18 engage into the lateral openings 16a of the inflow ducts 10 in order to provide sealing closure with the material of the filter plates 12. The teeth 19 of the sealing element 18 therefore close the enlargement or lateral opening 16a of the lateral regions 16 of the inflow ducts 10 resulting from the angled portions of the filter plates 12. This results, together with the abovementioned welding of the lateral regions 17 of the outflow ducts 11, in complete sealing of the filter body 6.

It can also be seen from FIG. 6 that the teeth 19 of the sealing element 18 are curved and that, in that region in which they engage in the lateral openings 16a of the inflow ducts 10, they run in the flow direction, denoted by “C”, of the exhaust gas flow.

The sealing element 18 is preferably connected both to the filter plates 12 and also to the housing 2 by means of welding, though it is also possible to use a soldering or adhesive process if the required strength of the connection between the components involved can be obtained in this way.

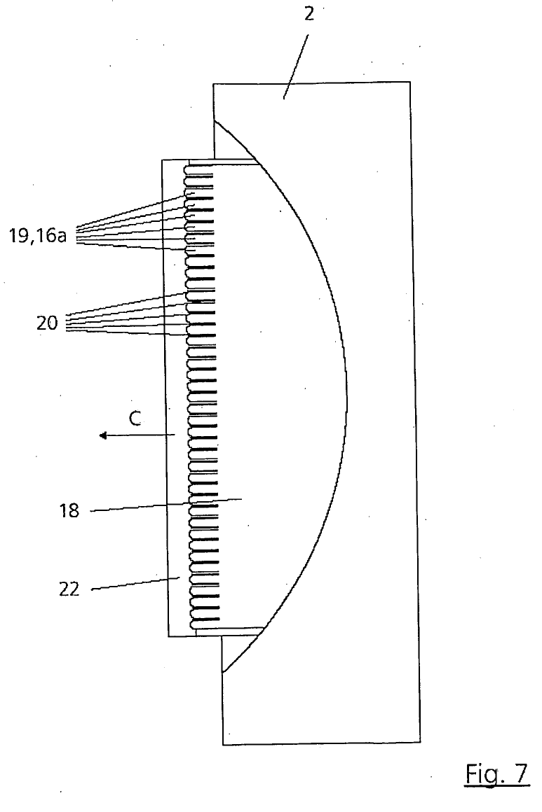

FIG. 7 illustrates the sealing element 18 in a side view. A clamping element 22 is additionally provided here, which clamping element is connected, in the two lateral regions, to the filter plates 12 and exerts an additional force on said filter plates 12 in order to press them with a greater force in the direction from the clean air side toward the teeth 19 of the sealing element 18. This provides further improved sealing of the filter body 6 with respect to the housing 2.

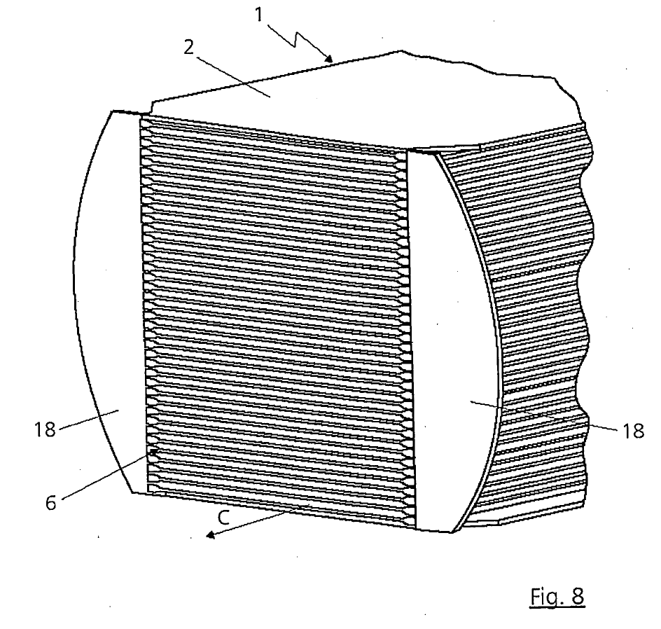

FIGS. 8 and 9 show an alternative embodiment of the sealing element 18. Here, as can be seen in particular in FIG. 8, the teeth 19 extend away from the sealing element 18 at an angle of substantially 90° and, in the region in which they engage in the lateral openings 16a of the inflow ducts 10, run counter to the flow direction “C” of the exhaust gas flow.

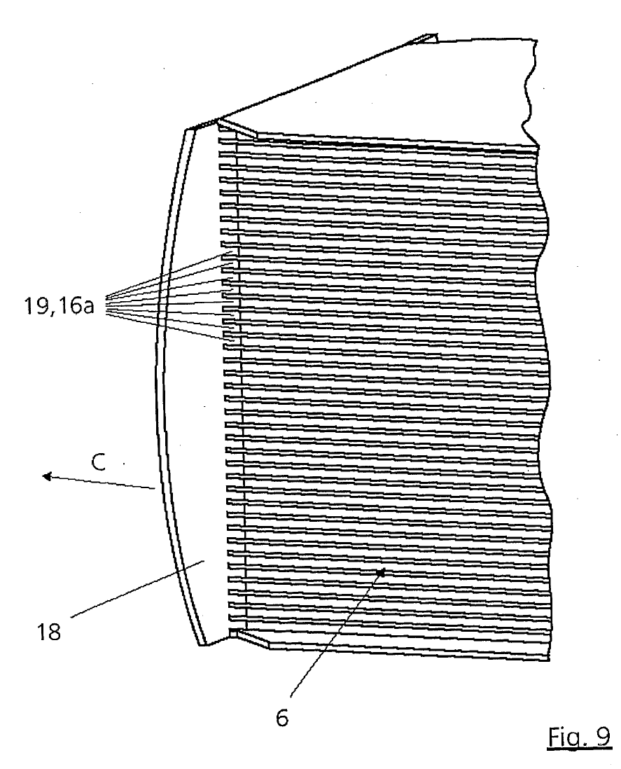

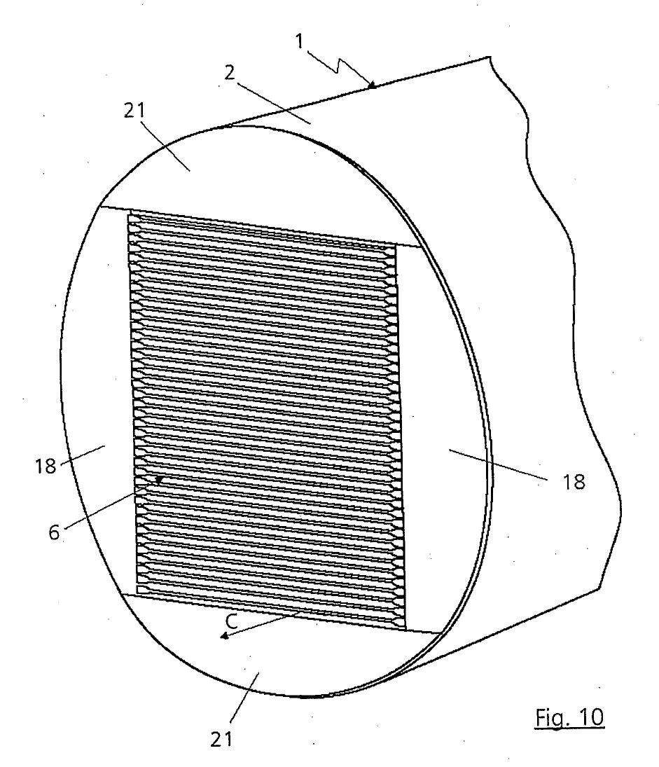

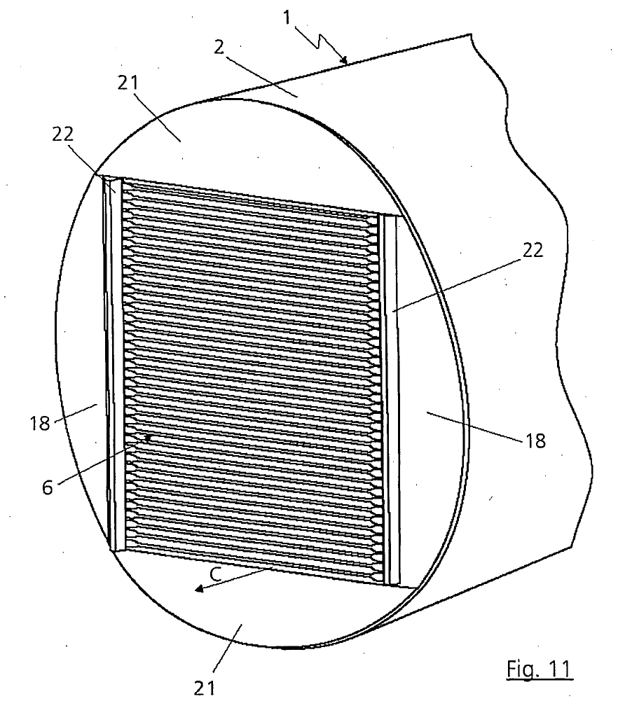

A further embodiment of the sealing element 18 is illustrated in FIGS. 10 and 11. Here, the teeth 19 run substantially in the direction of extent of the sealing element 18 from the housing 2 to the filter body 6 and therefore transversely with respect to the flow direction “C” of the exhaust gas flow. It can also be seen from FIG. 11 that one of the clamping elements 22 is attached at each of the two connections of the sealing elements 18 to the filter body 6. The two clamping elements 22 are in each case connected not only to the filter body 6 and the sealing element 18 but also to the housing 2. The clamping element 22 is preferably connected to the filter body 6, the sealing element 18 and the housing 2 by means of welding. The use of a soldering or adhesive process is again conceivable here. It is also possible, in a way which is not illustrated, to use the clamping elements 22 to connect the sealing elements 18 to the housing 2, so that the sealing elements 18 are connected only indirectly to the housing 2.

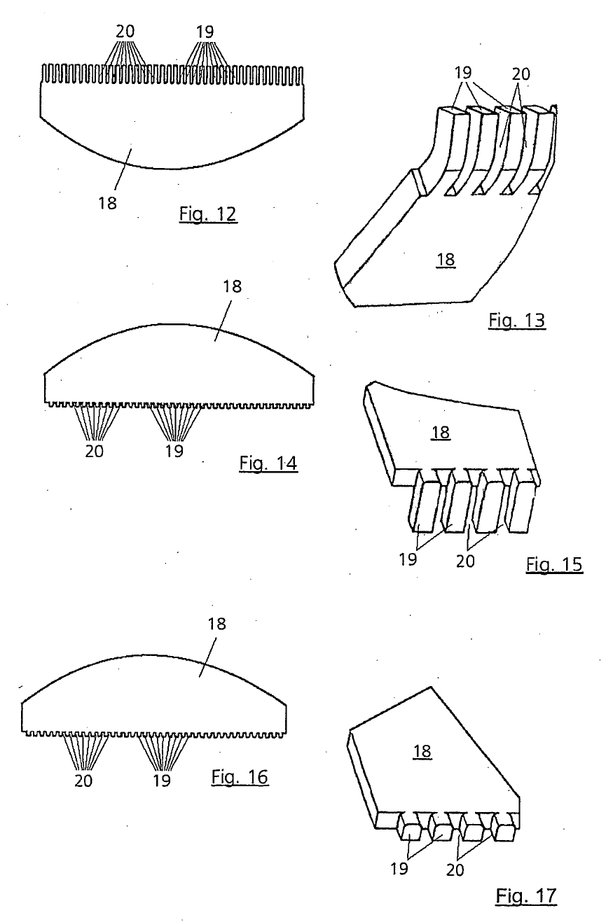

FIGS. 12 and 13 illustrate in more detail the shape of the sealing element 18 used in the embodiment of the particulate filter 1 as per FIGS. 5, 6 and 7. Similarly, FIGS. 14 and 15 show the shape of the sealing element 18 as per the embodiment of the particulate filter 1 of FIGS. 8 and 9, and FIGS. 16 and 17 show the shape of the sealing element 18 as per the embodiment of the particulate filter 1 of FIGS. 10 and 11.

1-11. (canceled)

12. A particulate filter for separating particulates out of an exhaust gas flow of an internal combustion engine, comprising:
a filter body having an inflow region and an outflow region, the filter body formed by alternately arranged inflow ducts, which are open toward the inflow region and are closed toward the outflow region, and outflow ducts, which are open toward the outflow region and closed toward the inflow region, the filter body also having a plurality of substantially planar filter plates arranged parallel to one another, with each of the inflow ducts and the outflow ducts being formed by adjacent filter plates,
a housing in which the filter body is arranged, and
at least one sealing element for sealing off the filter body in the outflow region relative to the housing,
wherein the inflow ducts are open at least at one of their lateral regions in such a way that the inflow region extends over at least two sides of the filter body.

13. The particulate filter as claimed in claim 12, wherein the sealing element forms a comb, which is connected at least indirectly to the housing and has teeth that engage in lateral openings of the inflow ducts.

14. The particulate filter as claimed in claim 12, wherein the inflow ducts are open at two lateral regions in such a way that the inflow region extends over three sides of the filter body.

15. The particulate filter as claimed in claim 12, wherein the sealing element is connected by way of an additional clamping element to the filter body.

16. The particulate filter as claimed in claim 15, wherein the additional clamping element is connected to the sealing element, the filter body and the housing.

17. The particulate filter as claimed in claim 12, further comprising at least one covering plate provided in addition to the sealing element, wherein the covering plate connects the filter body to the housing.

18. The particulate filter as claimed in claim 13, wherein the teeth are curved and, in the region in which they engage in the lateral openings of the inflow ducts, run in the flow direction of the exhaust gas flow.

19. The particulate filter as claimed in claim 13, wherein the teeth extend away from the sealing element at an angle of substantially 90° and, in the region in which they engage in the lateral openings of the inflow ducts, run counter to the flow direction of the exhaust gas flow.

20. The particulate filter as claimed in claim 13, wherein the teeth run substantially in the direction of extent of the sealing element from the housing to the filter body.

21. The particulate filter as claimed in claim 12, wherein the filter body is welded to the sealing element.

22. The particulate filter as claimed in claim 12, wherein the sealing element is welded to the housing.

23. The particulate filter as claimed in claim 13, wherein the inflow ducts are open at two lateral regions in such a way that the inflow region extends over three sides of the filter body.

24. The particulate filter as claimed in claim 13, wherein the sealing element is connected by way of an additional clamping element to the filter body.

25. The particulate filter as claimed in claim 14, wherein the sealing element is connected by way of an additional clamping element to the filter body.

26. The particulate filter as claimed in claim 13, further comprising at least one covering plate provided in addition to the sealing element, wherein the covering plate connects the filter body to the housing.

27. The particulate filter as claimed in claim 14, further comprising at least one covering plate provided in addition to the sealing element, wherein the covering plate connects the filter body to the housing.

28. The particulate filter as claimed in claim 15, further comprising at least one covering plate provided in addition to the sealing element, wherein the covering plate connects the filter body to the housing.

29. The particulate filter as claimed in claim 23, wherein the teeth are curved and, in the region in which they engage in the lateral openings of the inflow ducts, run in the flow direction of the exhaust gas flow.

30. The particulate filter as claimed in claim 24, wherein the teeth are curved and, in the region in which they engage in the lateral openings of the inflow ducts, run in the flow direction of the exhaust gas flow.

31. The particulate filter as claimed in claim 23, wherein the teeth extend away from the sealing element at an angle of substantially 90° and, in the region in which they engage in the lateral openings of the inflow ducts, run counter to the flow direction of the exhaust gas flow.
